(19) United States
(12) Patent Application Publication
(10) Pub. No.: US 2001/0029842 A1
(43) Pub. Date: Oct. 18, 2001

(54) Apparatus using high electric fields to extract water vapor from an air flow

(76) Inventor: Stuart A. Hoenig, Tucson, AZ (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/887,468

(22) Filed: Jun. 21, 2001

Related U.S. Application Data
(63) Continuation-in-part of application No. 09/551,333, filed on Apr. 18, 2000.

(51) Int. Cl. B03C 3/00

(52) U.S. Cl. 96/63

(57) ABSTRACT

A air dryer uses high voltage direct current to cause moisture to condense out of an airflow in contact with a network of needles creating a high intensity electric field within grounded shields. The moisture is collected in a basin positioned below the needles.

This application claims the filing date of a previously filed provisional application having Ser. No. 09/551,333 and an assigned filing date of Apr. 18, 2000 and which contains subject matter substantially the same as that described and claimed in the present application.

### BACKGROUND OF THE INVENTION

1. Field of the Invention

This invention relates generally to air dryers, and more particularly to a water vapor extractor using high strength electric fields.

2. Description of Related Art

The prior art teaches the use of cold, adsorptive and absorption surfaces for dehumidification. However, the prior art does not teach that a high voltage may be applied in the manner of the present invention to produce such effective dehumidification. The present invention fulfills these needs and provides further related advantages as described in the following summary.

### SUMMARY OF THE INVENTION

The present invention teaches certain benefits in construction and use which give rise to the objectives described below.

The present invention provides a water vapor extraction machine which uses high voltage to cause moisture to condense out of an airflow in contact with a series of needles. The needles are placed at a very high direct current voltage and the points of the needles are positioned in proximity to ground planes. An air flow is caused to move over these needles and through the high stress electric field. The effect is to extract moisture from the air flow which condenses on the needles and then drips downwardly so that it is taken out of the air circulation.

A primary objective of the present invention is to provide an air dryer having advantages not taught by the prior art.

Another objective is to provide such a device using high voltage electric fields to produce the drying effect.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a side elevation section view of a preferred embodiment of the present invention;

FIG. 2 is a rear view thereof;

FIG. 3 is a front view thereof; and

FIG. 4 is a section view taken along line 4-4 in FIG. 1.

### DETAILED DESCRIPTION OF THE INVENTION

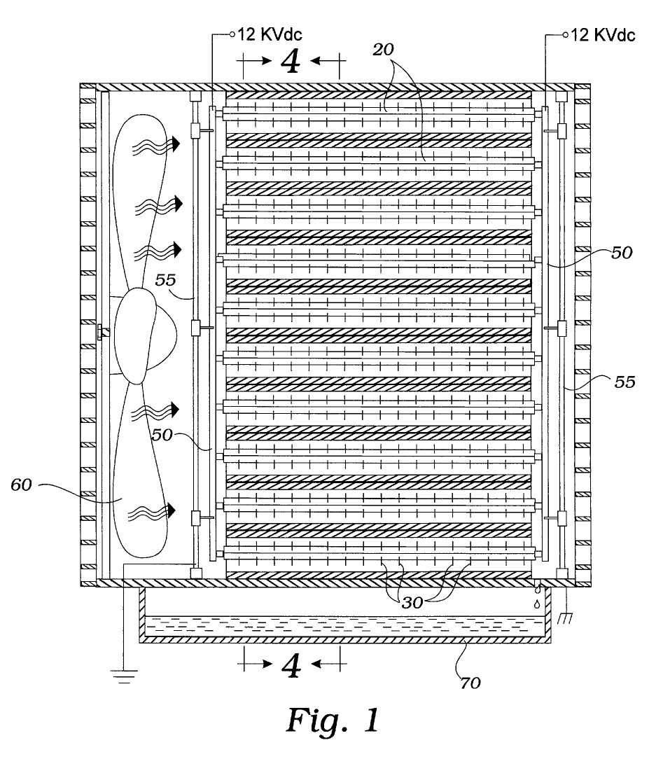

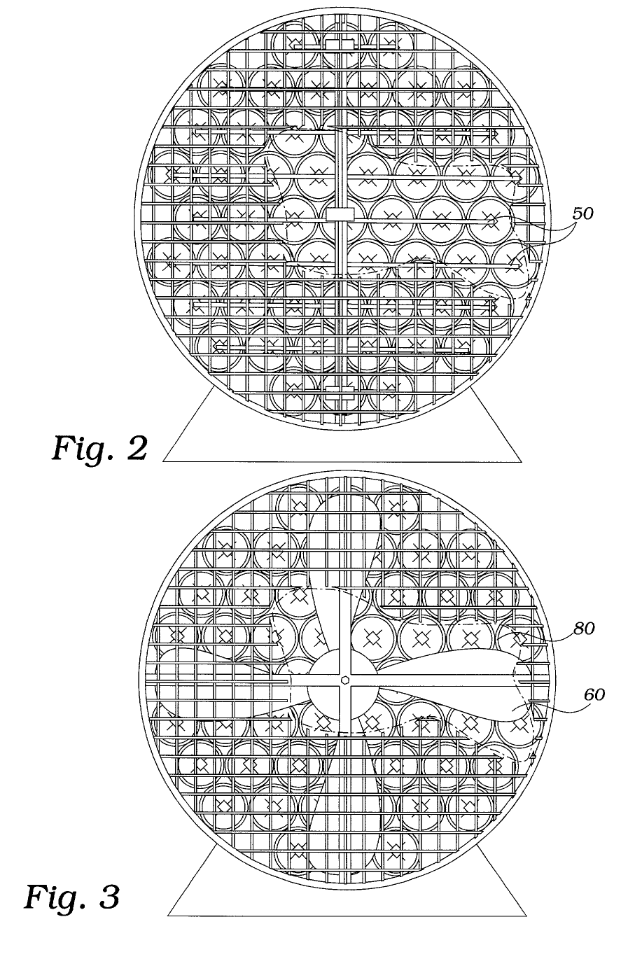

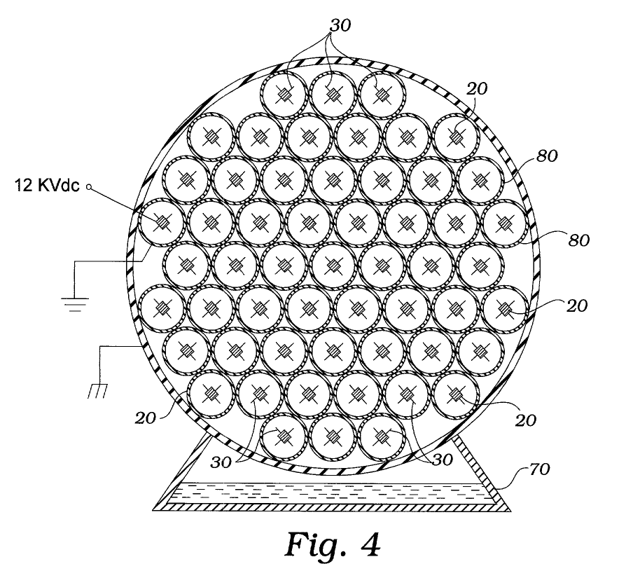

The drawings provide illustration of the present invention, an air drying apparatus comprising an electrical buss made up of a plurality of electrically conducting rods 20 arranged in mutually parallel orientation. This is clearly shown in FIG. 1. Each of the rods 20 is a structural element with rigidity and provides plural spaced apart needles 30 extending outwardly from the rods 20. The rods are preferably of a non-conducting material such as ceramic or such but the needles are interconnected electrically, possibly coaxially within the rods 20. The needles 30 each terminate with a point at its end. A means for directing a high voltage direct current 50 to the electrical buss rods 20 and therefrom to the needles 30 is provided as shown. As best seen in FIG. 1, the HVDC directing means 50 is a structural network grid of conductors. This is best seen in FIG. 2. A means for directing a flow of moist air 60 over the rods 20 and past the needles 30, preferably a fan, is used to assure the collection of moisture at a rate dependent on fan speed. A means for receiving water droplets 70 that are extracted from the moist air and formed at the points of the needles 30 for collection is provided as a basin or any similar container positioned appropriately (below) as shown in FIGS. 1 and 4. Electrically conductive cylinders 80 are positioned as shrouds about the rods 30 which are positioned centrally or axially within the cylinders 80. The cylinders 80 provide a conductive path to electrical ground and this may be constructed in accordance with the drawings by using rigid metal construction. Insulating supports 55 for the electrical directing means 50 are used to hold it in place.

In operation, an intense electric field is set up at the needles 30, and as shown in FIGS. 2-4, the field is concentrated at the points of the needles 30 since these points are closest to the inside surfaces of the cylinders 80, i.e., there is a concentration of electric field lines at the needle points, as is well known in the field of electrical engineering, at the tips of these needles. This very high electric field causes the extraction of moisture as liquid from the air in contact with the needle points. As moist air moves through the cylinders 60 it is subject to the intense electrical fields and moisture is thus extracted from the air and condenses onto the needles 30, and more specifically at the points of the needles 30. This moisture drops by gravity into the interior of the cylinders 80 and then flows in the direction of air flow to the rearward end of the cylinders 80 where it drips into the basin 70.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. An air drying apparatus comprising an electrical buss providing a plurality of electrically conducting rods arranged in mutually parallel orientation; each of the rods providing plural spaced apart needles extending outwardly from the rods, the needles each terminating with a point; a means for directing a high voltage direct current to the electrical buss and therefrom to the needles; a means for directing a flow of moist air between the rods and past the needles; and a means for receiving water droplets extracted from the moist air and formed at the points of the needles for collection.

2. The apparatus of claim 1 wherein the water droplets receiving means is a basin positioned below the needles so as to receive the water droplets.

3. The apparatus of claim 1 wherein the high voltage direct current directing means is a structural network grid of conductors.

4. The apparatus of claim 1 wherein the air flow directing means is a fan.

5. The apparatus of claim 1 further comprising a plurality of electrically conductive cylinders, each of the cylinders positioned as a shroud receiving one of the rods centrally therein, the cylinders providing a conductive path to electrical ground.
